(19) United States
(12) Patent Application Publication
(10) Pub. No.: US 2015/0304399 A1
(43) Pub. Date: Oct. 22, 2015

(54) RUNNING AGENTS TO EXECUTE AUTOMATION TASKS IN CLOUD SYSTEMS

(71) Applicant: HEWLETT-PACKARD DEVELOPMENT COMPANY, L.P., Houston, TX (US)

(72) Inventor: Jeffrey W. Kramer, Austin, TX (US)

(21) Appl. No.: 14/646,812

(22) PCT Filed: Nov. 30, 2012
(86) PCT No.: PCT/US12/67295

§ 371 Date: May 22, 2015

(51) Int. Cl. H04L 29/08; H04L 12/24; G06F 17/30

(52) U.S. Cl. CPC H04L 67/10; G06F 17/30312; H04L 41/0886

(57) ABSTRACT

Running an agent to execute an automation task in a cloud system can include receiving configuration data and location data from a database for the agent associated with the automation task in response to an identified scheduled run of the automation task, retrieving the agent using the location data and a distributed duster of servers, and running the agent to execute the automation task in the cloud system using the configuration data.

### BACKGROUND

Automation tasks, such as sending an email when a the is changed, triggering backups at scheduled times, and scaling infrastructure can be scheduled, run, and monitored using scripted tasks on a system. For example, the system can use a centralized management point to manage the automation tasks.

### BRIEF DESCRIPTION OF THE DRAWINGS

FIG. 1 illustrates a flow chart of an example of an environment for running an agent to execute an automation task in a cloud system according to the present disclosure.

FIG. 2 illustrates a block diagram of an example of a method for running an agent to execute an automation task in a cloud system according to the present disclosure.

FIG. 3 illustrates a block diagram of an example of a system according to the present disclosure.

### DETAILED DESCRIPTION

Cloud systems, such as a hybrid cloud system, are reshaping the Information Technology (IT) industry. Cloud systems can move workloads from a centrally hosted and managed center to a cloud system. In a traditional setting, automation tasks can be scheduled, monitored, and run using scripted tasks on the responsible systems. However, due to the distributed nature of cloud systems, cloud systems may lack a centralized management point.

A cloud system, as used herein, can refer to computational resources that can be linked through the use of computer networks. Example cloud systems can include a private cloud system, a public cloud system, and a hybrid cloud system.

Cloud systems may currently ignore automation tasks, relegate automation tasks to unrnaintained servers at a high incremental cost, and/or outsource automation tasks to external solution providers. For instance, a cloud oriented automation tool (e.g., Chef or Puppet) can target a specific service niche of managing server administrations. Such tools can effectively maintain a cluster of servers for an application but may not be able to go beyond the scope of instructions and configurations on a machine (e.g., a computing device). For example, such totals may not be designed to run automation tasks and may require significant training for automation tasks.

Products that provide cloud automation services can be designed around building and managing distributed cloud applications, building execution processes, and distributing workloads at cloud scale. Such services can enable a new application design paradigm but may be ill suited for automation tasks and/or tasks that do not fit their large scale design philosophy.

In contrast, examples in accordance with the present disclosure can provide a cloud agent service to create automation tasks in a cloud system. For instance, the cloud agent service can include a platform offered to users to create and/or configure agents that operate on the cloud system on behalf of the users. A configured agent can include a user independent script designed to support an automation task. The cloud agent service can have direct application programming interface (API) access, and can provide scheduling, notification, and security functions while leaving program logic up to a user (e.g., a developer). Further, an agent can be configured to contain self-describing script that supports a user-friendly user interface in the cloud management portal.

Systems, methods, and computer-readable and executable instructions are provided for running agents to execute automation tasks in loud systems. Running an agent to execute an automation task in a cloud system can include receiving configuration data and location data from a database for the agent associated with the automation task in response to an identified scheduled run of the automation task, retrieving the agent using the location data and a distributed cluster of servers, and running the agent to execute the automation task in the cloud system using the configuration data.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As used herein, “a” or “a number of” something can refer to one or more such things. For example, “a number of interactions” can refer to one or more interactions.

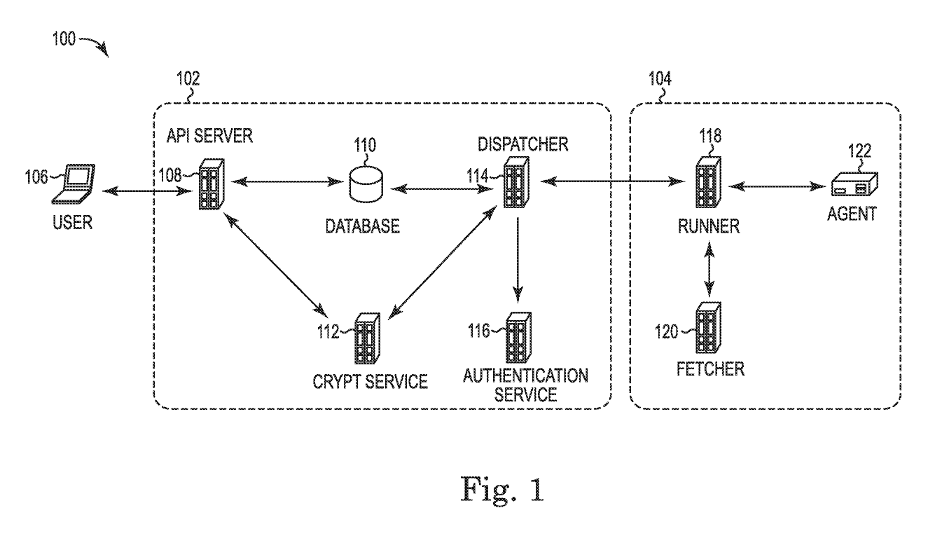

FIG. 1 illustrates a flaw chart of an example of an environment 100 for running an agent to execute an automation task in a cloud system 104 according to the present disclosure. The environment 100 can be provided to a user 106 as a cloud agent service. The cloud agent service can be used to create and manage a number of schedulable automation tasks in the cloud system 104. The arrows as illustrated in the example of FIG. 1 illustrate communication between services (e.g., sub-services) associated with and/or components of the cloud agent service.

The environment 100, as illustrated in FIG. 1, can include a secure service system 102 and a cloud system 104. The secure service system 102 can be a sub-portion of a network (e.g., collection of computing devices interconnected by communication channels to allow sharing of resources and information) separate from and/or associated with the cloud system 104. The network separate from and/or associated with the cloud system 104 can include a secure service network. A secure service network can be a network that can host a number of computing devices designated and/or designed to keep a cloud system 104 running. Providing the secure service system 102 as a sub-portion of a secure service network can offer security, as compared to the cloud system 104, due to security features of a secure service network (e.g., firewall). However, examples of the present disclosure are not so limited. In various examples, the secure service system 102 can be a sub-portion of the cloud system 104 (e.g., the secure service system 102 can reside in the cloud system 104).

A cloud system 104 can include a private cloud system, a public cloud system, and/or combination of a private cloud system with a public cloud system (e.g., hybrid cloud system). A private cloud system can include a computing architecture that provides hosted services to a limited number of nodes (e.g., computing devices) behind a firewall. A public cloud system can include a service provider that makes resources (e.g., applications and storage) available to the public over the Internet. A hybrid cloud system can include a private cloud system bound together with a public cloud system. For example, a hybrid cloud system can be formed by a vendor with a private cloud forming a partnership with a public cloud provider and/or by a pubic cloud provider forming a partnership with a vendor that provides private cloud platforms.

A service, as used herein, can include an intangible commodity offered to users in a cloud system. For instance, cloud services offered can include computing resources (e.g., storage, memory, processing resources) andler computer-readable instructions (e.g., programs).

The cloud agent service (e.g., the environment 100) can be presented to a user 106 as a service. The cloud agent service can utilize both the secure service system 102 and the cloud system 104. The cloud agent service can be used to develop and execute automation tasks. An automation task can include a schedulable task that can occur in response to an event using written script. The event can include a periodic predetermined time period and/or an event on the cloud system (e.g., updated file). For instance, using the cloud agent service, running a Configured agent to execute an automation task can occur on the cloud system 104 on behalf of the user without further action from the user.

A user 106 can develop and/or create an automation task by configuring an agent. An agent can include a user independent script designed to support an automation task. For instance, a user independent script can include script based on a common programming library (not illustrated in the example of FIG. 1). The common programming library can include a module for manipulating cloud services, making application programming interface (API) requests, and processing data.

The common programming library can be separate from the cloud agent service (e.g., separate from the environment 100). For instance, the common programming library can include an importable library containing scripting commands. A scripting command, as used herein, can include a script designed to handle a single task. For example, a single task can include: format a date, convert a graph and/or image, among other single tasks. An agent created using the common programming library may be more likely to work in the environment 100 than an agent built using a user dependent script.

The common programming library can provide a function for validating configurations and running agents without use of the cloud agent service. For instance, development, testing, and debugging of an agent can be done on a computing device of a user 106 (e.g., a developer of an agent) and the user 106 can import the agent to the environment 100 (e.g., the cloud agent service). The agent can be run on a server associated with the user 106 and/or inside a datacenter belonging to the user while still being portable into the cloud agent service. This can reduce concern for vendor lock-in. Vendor lock-in (e.g., proprietary lock-in or customer lock-in) can include lack of compatibility and/or interoperability between components (e.g., programs, file format, operating system, APIs, etc.). Vendor lock-in can result in user dependency on a vender for products and services, for instance.

A user 106 can schedule a task associated with an agent using the cloud agent service. The agent can include an existing agent and/or a new agent, and the user can configure the agent (e.g., existing or new) for a particular use (e.g., schedule the task). The configuration of the agent can include name, expiration, title, description, type, and/or requirements, among other configurations.

A configured agent can be self-describing. A self-describing agent, as used herein, can include an agent that contains the configuration data in the script of the particular agent (e.g., code and/or instructions of the agent). The configuration data can be used to provide a user-friendly user interface, such as a command line client (e.g., as discussed further herein).

The cloud agent service can be API driven. An API can include a specification to be used as an interface between computing device and/or computer-readable instruction components (e.g., program instructions). The specification, in some examples of the present disclosure, can be based on a common programming library. A plurality of users can list agents, determine configuration options for agents, schedule new automation tasks for agents, modify existing agents, and/or retrieve statuses for current and/or past task runs via an API (e.g., using the API server 108).

For instance, an agent can be configured by a user 106 using an API server 108 in the secure service system 102 to create an automation task. An API server 108, as used herein, can include a computer hardware system (e.g., a physical server) and/or computer-readable instructions designated and/or designed to provide a number of functions associated with the cloud agent service including providing direct access to APIs. The cloud agent service, including a configured agent, can run on the cloud system 104 on the user's 106 behalf without further action from the user. For example, the API server 108 can be used to provide a list of agents to a user, determine configuration options for agents, schedule new automation tasks for agents, modify existing agents, and/or retrieve statuses for current and/or past task runs via an API (e.g., using the API server 108). As an example, a plurality of users in the cloud system 104 can list agents using the cloud agent service.

Configuration data and location data associated with an agent can be stored in a database 110. A database, as used herein, can include a structured collection of data. For instance, the database 110 can include a cloud agent service database. The cloud agent service database can include a database containing a list of agents. For instance, the list can include configuration data and location data for each agent. The agents can be provided in a list to a user using the API server 108 and the database 110.

In some examples of the present disclosure, creating an automation task can include using a crypt service 112 to encrypt sensitive data associated with the agent. The crypt service 112 can include a computer hardware system (e.g., a physical server) and/or computer-readable instructions designated and/or designed to encrypt sensitive data associated with the agent. The sensitive data can include configuration data and/or location data associated with the agent. The crypt service 112 can include a separate cryptographic service that can maintain unique encryption keys for each user (e.g., user 106). In some examples, the crypt service 112 can include a crypt server, Secure user information associated with the agent may be encrypted when the agent is not in use (e.g., not run), for example. In various examples, the crypt service 112 can un-encrypt encrypted data in response to a request by a dispatcher service 114.

A dispatcher service 114 in the environment 100 can run to identify and/or determine if an automation task (e.g., associated with a configured agent) is scheduled to run. The dispatcher service 114 can include a computer hardware system (e.g., a physical server) and/or computer-readable instructions designated and/or designed to identify a scheduled task run. The dispatcher service 114 can run in the environment 100 (e.g., secure service system 102) whether the user 106 is present in the environment 100 and/or not. As an example, the dispatcher service 114 can continuously run in the environment 100.

The dispatcher service 114 can retrieve the configuration data and location data for the agent associated with an automation task from the database 110. For instance, the dispatcher service 114 can retrieve the configuration data and location data in response to identifying a scheduled run of the automation task. The identification can include identifying whether the automation task run (e.g., execution of the task) is scheduled and has not yet been performed.

In various examples, the dispatcher service 114 can request the crypt service 112 un-encrypt encrypted data. The encrypted data can include a portion and/or all of the configuration data and/or a portion and/or all of the location data associated with the agent.

In some examples, the dispatcher service 114 can request a credential for the agent from an authentication service 116, The authentication service 116 can include a computer hardware system (e.g., a physical server) and/or computer-readable instructions containing the credential for the agent from the owning user (e.g., user 106). The credential for the agent, as used herein, can include an access token. An access token can include security and identification data for the user 106.

The dispatcher service 114 can request and/or identify a distributed cluster of servers 118, 120 inside the cloud system 104 to execute the automation task, A distributed cluster of servers 118, 120 can include multiple servers that communicate and/or interact through the cloud system 104. The distributed cluster of servers 118, 120 can include execution servers, for instance. The dispatcher service 114 can send the configuration data and location data associated with the agent to the distributed cluster of servers 118,120 using hypertext transfer protocol secure (HTTPS), for instance.

The distributed cluster of servers 118, 120 can include a runner service 118 and a fetcher service 120, in some examples. The runner service 118 can include a computer hardware system (e.g., a physical server) and/or computer-readable instructions designated and/or designed to receive the configuration data and location data, and send the location data to the fetcher service 120. The runner service 118, in various examples, may not send the configuration data to the fetcher service 120 to provide for added security (e.g., as discussed further herein).

The fetcher service 120 can include a computer hardware system (e.g., a physical server) and/or computer-readable instructions designated and/or designed to retrieve the agent (e.g., the file of the agent). For example, the fetcher service 120 can retrieve the agent using the location data. The agent can be located, for instance, in the user's (e.g., user 106) cloud storage, in an external server, and/or from an external HTTPS uniform resource locator (URL). In some instances, the agent can be located on the distributed cluster of servers 118, 120. In various examples, the fetcher service 120 and/or the runner service 118 can create a secure environment (e.g., as illustrated by agent 122 in the example of FIG. 1) for the agent to run in (e.g., as discussed further herein).

The runner service 118 can pass the configuration data into the standard input of the agent 122 and run the agent 122. A standard input can include input computer-readable instructions (e.g., data going into the agent). Running the agent 122 can include executing the automation task associated with the configured agent. The agent 122 can output a status message to its standard output. A standard output can include output computer-readable instructions (e.g., data written by the agent 122 as output data). The runner service 118 can send the output status message back to the database 110 for retrieval by the user 106 (e.g., using the dispatcher service 114). The output status message can be retrieved by the user 106 in near real time using an API (e.g., using the API server 108).

The runner service 118 and the fetcher service 120 can be run on separate servers (e.g., as illustrated by FIG. 1), in various examples of the present disclosure. Using separate servers for the fetcher service 120 and the runner service 118 can provide added security compared to using the same server because the fetcher service 120 may have and/or be given lower credentials and/or permissions than the runner service 118. Giving the fetcher service 120 lower credentials and/or permissions can provide added security as the fetcher service 120 can be given access to a database and/or server where the agent is located (e.g., may contain unsecure and/or private data). However, examples of the present disclosure are not so limited. The runner service 118 and the fetcher service 120, in some examples, can be run and/or executed using a single server.

In some examples of the present disclosure, if the fetcher service 120 cannot locate the agent, the user 106 can use the API server 108 to determine the issue and/or a solution. For instance, the user 106 can send a request to the API server 108 to determine the issue and/or solution.

As illustrated by the example of FIG. 1, the secure service system 102 can include the API server 108, the database 110, the crypt service 112, the dispatcher service 114, and/or the authentication service 116. The secure service system 102 can reside in a sub-portion of a secure service network and/or the secure service system 102 can reside in a sub-portion of the cloud system 104. Thereby, the cloud agent service, in various examples, can reside entirely in the cloud system 104.

A cloud agent service that resides entirely in the cloud system 104 can be run on one server and/or multiple servers in the cloud system 104. For example, the secure service system 102 that is a sub-portion of the cloud system 104 can reside and/or be run by a server in the cloud system 104 that is in a secure sub-portion of the cloud system 104. The distributed cluster of servers (e.g., the runner service 118 and fetcher service 120) can reside and/or be run by a server in the cloud system 104 that is less secure than the server running the secure service system 102.

For instance, the secure service system 102 can reside in a private cloud system and/or in a public cloud system in the respective cloud system's secure service network and/or in a secure area of the respective cloud system. The distributed cluster of servers 118, 120 that run the agent can reside in a separate cloud, multiple clouds, and/or reside in a public cloud system and/or private cloud System. As an example, in a hybrid cloud system, the secure service system 102 can reside in a private cloud system and the distributed cluster of servers 118, 120 can reside in a public cloud system.

Providing the environment 100 to users of a cloud system as a service (e.g., cloud agent service) can allow a user (e.g., a developer) to develop automation tasks in the cloud system with minimal effort, minimal training (e.g., because of user-friendly interfaces), and that are more likely to effectively work without significant cost as compared to relegating the automation tasks to unmaintained servers and/or outsourcing the automation tasks to external solutions providers. Further, the environment 100 can minimize vendor-lock in concerns as compared to products and/or external solutions that provide cloud automation services.

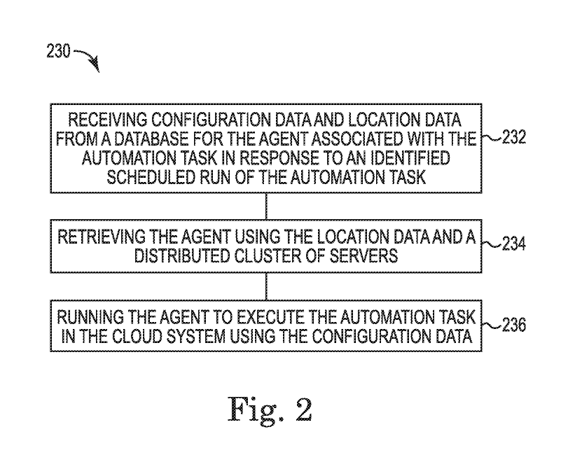

FIG. 2 illustrates a block diagram of an example of a method 230 for running an agent to execute an automation task in a cloud system according to the present disclosure. The method 230 can be used to manage scheduled automation tasks in a cloud system. The method 230 can be provided to a user as a part of a cloud agent service, for instance.

At 232, the method 230 can include receiving configuration data and location data from a database for the agent associated with the automation task in response to an identified scheduled run of the automation task. The configuration data can include a self-describing script of the agent (e.g., as discussed with respect to FIG. 1) and the location data can include a location of the file containing the agent (e.g., a storage location in the cloud system). The configuration data and location data can be received by a distributed duster of servers, for instance. The distributed cluster of servers can include a runner service and/or a fetcher service, in some examples of the present disclosure.

The configuration data and location data can, in various examples, be retrieved from a database (e.g., cloud agent service database) using a dispatcher service. The dispatcher service can, for instance, be used to identify the scheduled run, retrieve the configuration and location data, and send the configuration and location data to the distributed cluster of servers.

In various examples of the present disclosure, an agent can be configured to execute and/or schedule a plurality of automation tasks. The plurality of automation tasks can include periodic executions of the automation task associated with the agent. The periodic executions can be in response to multiple occurrences of an event (e.g., each time a file is updated in the cloud system) and/or predetermined periods of time (e.g., hourly, daily, and weekly, among other time periods).

At 234, the method 230 can include retrieving the agent using the location data and the distributed cluster of servers. The agent can be retrieved, in various examples, using a fetcher service on the distributed cluster of servers. The fetcher service can have limited permissions (e.g., credentials) to retrieve the agent to provide added security. Retrieving the agent, as used herein, can include locating the agent using the location data and downloading the agent into a secure environment.

At 236, the method 230 can include running the agent to execute the automation task in the cloud system using the configuration data. The agent can be run, for example, using a runner service on the distributed cluster of Servers. For instance, the agent can be run in a secure environment using the distributed cluster of servers. The distributed cluster of servers, in various examples, can create the secure environment.

A secure environment can include an operating space. An operating space, as used herein, can include a location on a hard-drive. In various examples, an operating space can include a directory. A directory can, for instance, include a file system structure (e.g., operating space) in which to store and/or organize computer files.

Creating a secure environment can include creating an operating space for the agent to be downloaded into and run in. The operating space created can include a unique operating space owned by a unique user, for instance, so that other users in the cloud system can not see the agent's files and/or access the agent. The agent can be downloaded directly into the operating space and renamed a generic file name. Renaming the agent can provide added security because even if the operating space is listed, the listing of the operating space may not identify the agent. The agent can be run, in some examples, as the unique user. Once the agent has been run to execute the automation task, the information and/or data in the operating space can be deleted. In various examples, the runner service can create the operating space, ensure that the operating space is owned by a unique user, run the agent, and delete the information and/or data from the operating space. The fetcher service can, in some examples, download the agent into the operating space and/or rename the agent.

The secure environment that the agents run in can, for instance, be limited in memory, number of files, number of processes, and/or amount of time that can be used for execution of instructions. Such limitations can be communicated to the agent (e.g., using an API) so that when the agent is run, the agent can make decisions about functional approaches (e.g., according to an algorithmic approach).

In accordance with some examples of the present disclosure, a status of the execution of the automation task can be output. Far instance, the agent can output the status. The output status (e.g., message) can be sent to the database (e.g., cloud agent service database) using the runner service and can be retrieved by the user using the API server. For example, the runner service can send the output status to the dispatcher service which can send the output status to the database for storage.

In various examples, the method can include sending a notification to the user of an output status of the execution of the automation task and storing the output in the database for retrieval by the user. For example, the agent can emit a notification request to the cloud agent service when a situation is encountered about which the user may need to be notified. The notification request can be delivered to the user using the cloud agent service. For instance, the cloud agent service can send the notification to the user as an email and/or other text message.

In some examples, the agent can have access to the common programming library for manipulating a cloud service, making API requests, and Processing data. When an agent is run, the agent executes its script (e.g., instructions), retrieves data, and acts on the cloud system on behalf of a user. Because the agent is built as a cloud service (e.g., cloud agent service), the agent can use the API server to create new automation tasks and/or update existing automation tasks (e.g., create a revised automation task). As an example, an agent can self-modify its configurations for the next run.

The cloud agent service, in various examples, can provide a private, encrypted database for agents. The agents can store data in between task runs in the database. Thereby, an agent can maintain its own state in a number of forms (e.g., encoded language object, binary tree, and/or simple plain text).

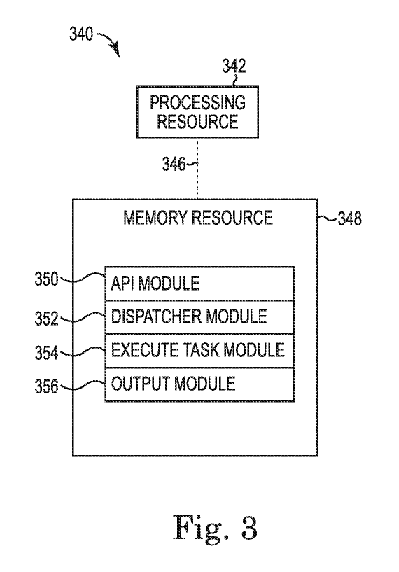

FIG. 3 illustrates a block diagram of an example of a system 340 according to the present disclosure. The system 340 can utilize software, hardware, firmware, and/or logic to perform a number of functions.

The system 340 can be any combination of hardware and program instructions configured to run an agent to execute an automation task in a cloud system. The hardware, for example can include a processing resource 342, a memory resource 348, and/or computer-readable medium (CRM) (e.g., machine readable medium (MRM), database, etc.) A processing resource 342, as used herein, can include any number of processors capable of executing instructions stored by a memory resource 348. Processing resource 342 may be integrated in a single device or distributed across devices. The program instructions (e.g., computer-readable instructions (CRI)) can include instructions stored on the memory resource 348 and executable by the processing resource 342 to implement a desired function (e.g., identify a scheduled run of an automation task associated with an agent, etc.).

The memory resource 348 can be in communication with a processing resource 342. A memory resource 348, as used herein, can include any number of memory components capable of storing instructions that can be executed by processing resource 342. Such memory resource 348 is non-transitory CRM. Memory resource 348 may be integrated in a single device or distributed across devices. Further, memory resource 348 may be fully or partially integrated in the same device as processing resource 342 or it may be separate but accessible to that device and processing resource 342. Thus, it is noted that the system 340 may be implemented on a user and/or a client device, on a server device and/or a collection of server devices, and/or on a combination of the user device and the server device and/or devices.

The processing resource 342 can be in communication with a memory resource 348 storing a set of CRI executable by the processing resource 342, as described herein. The CRI can also be stored in remote memory managed by a server and represent an installation package that can be downloaded, installed, and executed. The system 340 can include memory resource 348, and the processing resource 342 can be coupled to the memory resource 348.

Processing resource 342 can execute CRI that can be stored on an internal or external memory resource 348. The processing resource 342 can execute CRI to perform various functions, including the functions described with respect to FIG. 1 and FIG. 2. For example, the processing resource 342 can execute CRI to run an agent to execute an automation task for a particular user in a cloud system.

The CRI can include a number of modules 350, 352, 354, 356. The number of modules 350, 352, 354, 356, can include CRI that when executed by the processing resource 342 can perform a number of functions.

The number of modules 350, 352, 354, 356 can be sub-modules of other modules. For example, the execute task module 354 and the output module 356 can be sub-modules and/or contained within the same computing device. In another example, the number of modules 350, 352, 354, 356 can comprise individual modules at separate and distinct locations (e.g., computer-readable medium, etc.).

In some examples, the system can include an API module 350. An API module 350 can include CRI that when executed by the processing resource 342 can provide a number of API functions. The API module 350 can schedule an automation task associated with an agent using an API server. For instance, a user can make a request for a scheduled task. The request can, for instance, include inputs from the user identifying a configuration for an agent to execute a particular scheduled automation task. Alternatively and/or in addition, in various examples, the API module 350 can include instructions to provide API server access to an agent. For instance, the agent can use the API server to create new automation tasks and/or update existing automation tasks (e.g., create a revised automation task).

The API module 350, in some examples of the present disclosure, can include instructions to provide a list of agents to a user, allow a user to determine configuration options for an agent, schedule a new task for an agent, modify an existing task, and/or retrieve a status for a current and/or past execution of a task. As an example, an agent can be configured to execute a plurality of automation tasks. For instance, a user can configure the agent to execute an automation task a plurality of times in response to an event and/or periodically (e.g. execute the automation task at a plurality of periodic predetermined times).

Alternatively and/or in addition, a user can configure an agent for a particular automation task. For example, a list of agents can be stored in a cloud agent service database. A user can access the list containing location data and configuration data for each of a plurality of existing agents and can configure a particular agent for the user's use to execute a one-time automation task using the API module 350.

In various examples, the system can include an agent display module (not illustrated in the example of FIG. 3). An agent display module can include CRI that when executed by the processing resource 342 can display a cloud agent interface, such as a command line client (e.g., a stand-alone command line execution), in a cloud management portal (e.g., a hub provided to each user to provision computing devices and/or resources, manage account information, and monitor performance) using the self-describing script of the agent. For example, a list of agents (e.g., configuration data and location data associated with each agent) stored in the cloud agent service database can be displayed to a user on a user interface (e.g., a cloud agent interface). A user interface can include hardware and/or computer-readable instruction components for users to interact with a computing device using text commands and/or images. The user interface can be displayed using the configuration data of each agent (e.g., the self-describing script).

A dispatcher module 352 can include CRI that when executed by the processing resource 342 can perform a number of dispatching functions. The dispatcher module 352 can identify a scheduled run of an automation task associated with an agent and send configuration data and location data associated with the agent to a runner service (e.g., using a dispatcher service). In various examples, the dispatcher module 352 can include instructions to retrieve the configuration data and location data for the agent from a database. The dispatcher module 352 can be continuously run to identify scheduled runs of a plurality of automation tasks associated with the agent and/or a plurality of agents, for instance.

In some examples, the dispatcher module 352 can include instructions to request and/or identify a distributed cluster of servers to perform the functions associated with the execute task module 354. Further, in some examples, the dispatcher module 352 can include instructions to request a credential for an agent from a cloud authentication service.

An execute task module 354 can include CRI that when executed by the processing resources 342 can perform a number of execute task functions. The execute task module 354 can run the agent, using the runner service, to execute the automation task in the cloud system, wherein the runner service uses the configuration data and the location data. The execute task module 354 can include instructions to use a server to perform the number of execute task functions (e.g., a runner server and/or a fetcher server). In various examples, the execute module 354 can store an output status from an execution of the automation task (e.g., as output by the output module 356 as discussed further herein).

The execute task module 354, in some examples, can include instructions to retrieve the agent using the location data (e.g., the location data sent from the dispatcher module 352). In some instances, the execute task module 354 can include instructions to create a secure environment (e.g., an operating space) to run the agent in to execute the automation task.

In various examples of the present disclosure, the execute task module 354 can include a plurality of individual modules on separate and distinct computing devices. For instance, the individual modules can include a runner module and a fetcher module. The runner module can receive the configuration data and location data from the dispatcher module 352, send the location data to the fetcher module, and run the agent to execute the automation task. The fetcher module can locate and retrieve the agent using the location data.

An output module 356 can include CRI that when executed by the processing resource 342 can perform a number of output functions. The output module 356 can output a status (e.g., a message) from the execution of the automation task. In some examples, the output status can be sent to a database (e.g., using the execute task module 354 and/or the runner module).

A memory resource 348, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 348 can be integral, or communicatively coupled, to a computing device, in a wired and/or a wireless manner. For example, the memory resource 348 can be an internal memory, a portable memory, a portable disk, or a memory associated with another computing resource (e.g., enabling CRIs to be transferred and/or executed across a network such as the Internet).

The memory resource 348 can be in communication with the processing resource 342 via a communication path 346. The communication path 346 can be local or remote to a machine (e.g., a computing device) associated with the processing resource 342. Examples of a local communication path 346 can include an electronic bus internal to a machine (e.g., a computing device) where the memory resource 348 is one of volatile, non-volatile, fixed, and/or removable storage medium in communication with the processing resource 342 via the electronic bus.

The communication path 346 can be such that the memory resource 348 is remote from the processing resource (e.g., 342), such as in a network connection between the memory resource 348 and the processing resource (e.g., 342). That is, the communication path 346 can be a network connection. Examples of such a network connection can include a local area network (LAN), wide area network (WAN), personal area network (PAN), and the Internet, among others. In such examples, the memory resource 348 can be associated with a first computing device and the processing resource 342 can be associated with a second computing device (e.g., a Java® server). For example, a processing resource 342 can be in communication with a memory resource 348, wherein the memory resource 348 includes a set of instructions and wherein the processing resource 342 is designed to carry out the set of instructions.

The processing resource 342 coupled to the memory resource 348 can execute CRI to identify a scheduled run of an automation task associated with an agent. The processing resource 342 coupled to the memory resource 348 can also execute CRI to send configuration data and location data associated with the agent to a runner service using a dispatcher service. The processing resource 342 coupled to the memory resource 348 can also execute CRI to run the agent, using the runner service, to execute the automation task in the cloud system, wherein the runner service users the configuration data and the location data. Further, the processing resource 342 coupled to the memory resources 348 can also execute CRI to output a status from the execution of the automation task.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A computer-implemented method for running an agent to execute an automation task in a cloud system, the method comprising:
receiving configuration data and location data from a database for the agent associated with the automation task in response to an identified scheduled run of the automation task;
retrieving the agent using the location data and a distributed cluster of servers; and
running the agent to execute tree automation task in the cloud system using the configuration data.

2. The method of claim 1, further including creating an operating space for running the agent in using the distributed cluster of servers.

3. The method of claim 1, further including creating a revised automation task using the agent and an application programming interface (API) server.

4. The method of claim 1, further including scheduling a plurality of periodic executions of the automation task associated with the agent.

5. The method of claim 1, further including retrieving a status of the execution of the automation task using an application programming interface (API).

6. The method of claim 1, further including sending a notification to a user of an output status of the execution of the automation task and storing the output status in the database for retrieval by the user.

7. A non-transitory computer-readable medium storing a set of instructions executable by a processor to cause a computer to:
identify a scheduled run of an automation task associated with an agent;
send configuration data and location data associated with the agent to a runner service using a dispatcher service;
run the agent, using the runner service, to execute the automation task in the cloud system, wherein the runner service uses the configuration data and location data; and
output a status from the execution of the automation task.

8. The medium of claim 7, wherein the agent includes a user independent script designed to support the automation task.

9. The medium of claim 7, wherein the instructions executable by the processor include instructions to display a cloud agent user interface in a cloud management portal using the agent.

10. The medium of claim 7, wherein the instructions executable by a processor include instructions to request a credential for the agent from an authentication service using the dispatcher service.

11. The medium of claim 7, wherein the instructions executable by the processor include instructions to continuously run the dispatcher service to identify scheduled runs of a plurality of automation tasks associated with a plurality of agents.

12. A system for running an agent to execute an automation task in a cloud system, the system comprising a processing resource in communication with a non-transitory computer-readable medium, wherein the non-transitory computer-readable medium includes a set of instructions and wherein the processing resource is designed to carry out the set of instructions to:
schedule the automation task associated With the agent using an application programming interface (API) server;
encrypt configuration data and location data associated with the agent using a crypt service;
store the configuration data and location data in a database;
send, using a dispatcher service, the configuration data and location data from the database to a runner service, in response to an identified scheduled run of the automation task;
retrieve the agent using the location data and a fetcher service;
run the agent, using the runner service, to execute the automation task in the cloud system, wherein the runner service uses the configuration data; and
output a status from the execution of the automation task.

13. The system of claim 12, wherein the system is provided as a cloud agent service in the cloud system for creating and executing a plurality of automation tasks.

14. The system of claim 12, further including instructions to provide a list of a plurality of agents available for use using the API server and the database.

15. The system of claim 12, further including instructions to provide a common programming library containing scripting commands to the user to configure the agent.
